(19) United States
(12) Patent Application Publication
(10) Pub. No.: US 2025/0256401 A1
(43) Pub. Date: Aug. 14, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: REIKO YAO, Tokyo (JP)

(21) Appl. No.: 19/044,153

(22) Filed: Feb. 3, 2025

(30) Foreign Application Priority Data
Feb. 14, 2024 (JP) 2024-020684

(51) Int. Cl. B25J 9/16; B25J 11/00; G05D 1/648; G05D 105/10

(52) U.S. Cl. CPC B25J 9/1679; B25J 11/0085; G05D 1/6482; G05D 2105/10

(57) ABSTRACT

In an information processing apparatus, space information is acquired, wherein the space information is information of a physical space, work specification information is acquired, wherein the work specification information is specification information of work performed by an autonomously moving movable apparatus in the physical space, lacking information that is lacking with respect to the space information is determined based on the work specification information for planning execution of the work that is defined by the work specification information, and the lacking information that was determined is presented to a requester of the work.

### BACKGROUND OF THE INVENTION

### Field of the Invention

The present invention relates to an information processing apparatus, an information processing method, a storage medium, and the like.

### Description of the Related Art

In recent years, services such as robot sharing have become widespread. When utilizing a robot sharing service, it is necessary to select a robot suitable for the work environment, and for that purpose, it is necessary to provide work environment information. However, assuming factories, offices, and general households, the work environment includes highly confidential and private information that must be taken into consideration.

In response to this, Japanese Patent Laid-open Publication No. 2023-055133 describes a technology that determines a reward grant rate according to the degree of acceptance in order to promote data collection in residential units while considering the privacy information of residents in a smart city. Specifically, the number and operating mode of sensors are determined according to the degree of acceptance by residents, and in a case in which the degree of acceptance is high, the reward is set to be larger compared to a case in which the degree of acceptance is low.

However, the technology in Japanese Patent Laid-open Publication No. 2023-055133 is a technology related to data collection apparatuses and data collection methods, and cannot protect privacy, confidentiality, and the like in physical space information when making a work plan for robots. In addition, when making a work plan for robots, it is not possible to appropriately acquire lacking information that is lacking related to spatial information.

### SUMMARY OF THE INVENTION

An information processing apparatus comprising
one or more memories storing instructions; and
one or more processors executing the instructions to:
acquire space information, wherein the space information is information of a physical space;
acquire work specification information, wherein the work specification information is specification information of work performed by an autonomously moving movable apparatus in the physical space;
determine, based on the space information and the work specification information, lacking information that is lacking with respect to the space information for planning execution of the work that is defined by the work specification information; and
   present the lacking information that was determined to a requester of the work.

Further features of the present invention will become apparent from the following description of embodiments with reference to the attached drawings.

### BRIEF DESCRIPTION OF THE DRAWINGS

FIG. 1 is a diagram showing an example of an application scenario of an information processing apparatus 200 according to a First Embodiment.

FIG. 2 is a functional block diagram showing a configuration example of the information processing apparatus 200 according to the First Embodiment.

FIG. 3 is a flowchart showing an example of a basic processing flow according to the First Embodiment.

FIG. 4 is a diagram showing an example of information about a physical space according to the First Embodiment.

FIG. 5 is a diagram showing an example of a user interface when performing concealment processing with respect to information about a physical space according to the First Embodiment.

FIG. 6 is a diagram showing an example of a user interface when presenting information that is lacking to a requester in the First Embodiment.

FIG. 7 is a functional block diagram showing a configuration example of an information processing apparatus 700 according to a Second Embodiment.

FIG. 8 is a flowchart showing a basic processing flow according to the Second Embodiment.

FIG. 9 is a diagram showing a hardware configuration example of the information processing apparatus according to First to Third Embodiments.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

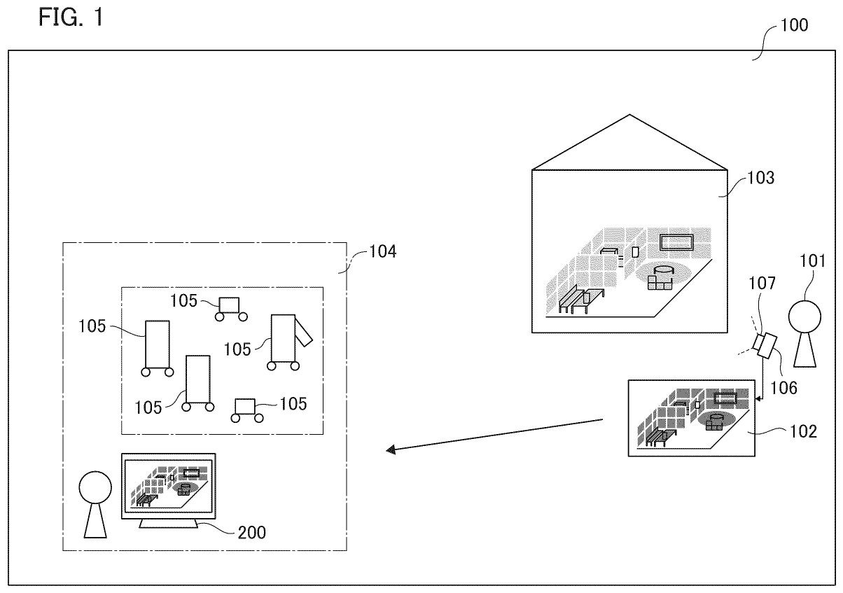

FIG. 1 is a diagram showing an example of an application scenario of an information processing apparatus 200 according to a First Embodiment of the present invention. In the present embodiment, an example will be explained of using a robot sharing service and requesting floor cleaning work. It should be noted that in the following explanation, information that is not disclosed to the robot sharing service provider, that is, information that includes privacy and confidentiality and the like to be concealed, is referred to as “confidential information”.

It should be noted that in the present embodiment, although an example of an autonomously moving cleaning robot is explained as a movable apparatus, the robot may be a robot that performs any kind of work. Furthermore, the present invention may also be applied to movable apparatuses such as drones or vehicles and the like that are capable of autonomous operation, in addition to robots.

In FIG. 1, reference numeral 100 is a diagram representing a scenario of requesting cleaning work using a robot sharing service. A requester 101 operates an information processing terminal 106 such as a smartphone and the like, and uses a spatial information measurement apparatus 107 such as a camera that is connected to the information processing terminal 106 so as to perform image capturing (sensing) of the entire space that includes a location 103 in which the cleaning work is requested.

It should be noted that the spatial information measurement apparatus 107 may be a sensor such as a LiDAR (Light Detection And Ranging) and the like connected to the information processing terminal 106.

Reference numeral 102 denotes spatial information, such as image data and the like, obtained by the requester using the spatial information measurement apparatus 107, such as a camera connected to the information processing terminal 106, to sense the entire space including the space that becomes the work target. It should be noted that spatial information such as image data includes depth image data and the like.

In the present embodiment, image data 120, which has sensed the entire space, for example, is referred to as information of the physical space. For this information of the physical space, the requester 101 specifies a region that becomes the target of the work, and at the same time, after applying concealment processing to regions that include information related to privacy and confidentiality, sends the processed information of the physical space to a robot sharing company 104.

By concealing information related to privacy and confidentiality, although information leakage risk can be reduced, when planning execution of work, because information within the space in which concealment processing has been applied becomes unclear, an impact occurs wherein the work execution plan cannot be strictly performed.

The robot sharing company 104 has a plurality of robots 105 having different performance and functions, performs business of lending out the plurality of robots, and performs predetermined processing by using the information processing apparatus 200 based on, for example, image data 120 that is information of the entire physical space. Then, the information processing apparatus 200 presents information that is lacking for planning the execution of the work to the requester 101.

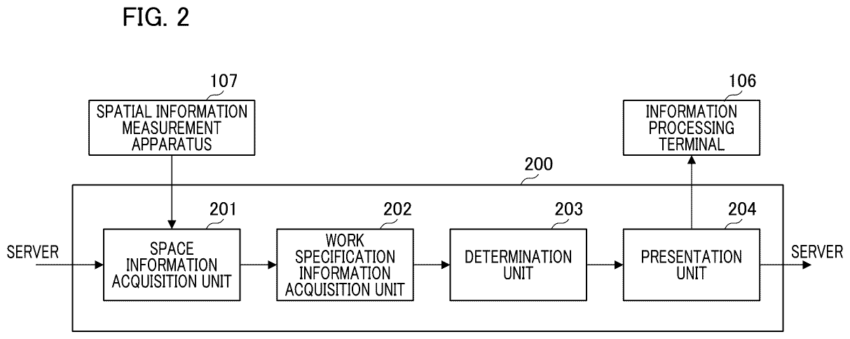

FIG. 2 is a functional block diagram showing a configuration example of the information processing apparatus 200 according to the First Embodiment. Although the following explains a configuration example of the main parts of the information processing apparatus 200, the information processing apparatus 200 may be provided with other functional blocks besides these.

It should be noted that some of the functional blocks shown in FIG. 2 are realized by causing a CPU 31, which serves as a computer in the information processing apparatus, to execute a computer program stored in memory serving as a storage medium.

However, some or all of the functional blocks may be configured to be realized by hardware. As hardware, a dedicated circuit (ASIC), a processor (a reconfigurable processor, DSP), and the like can be used.

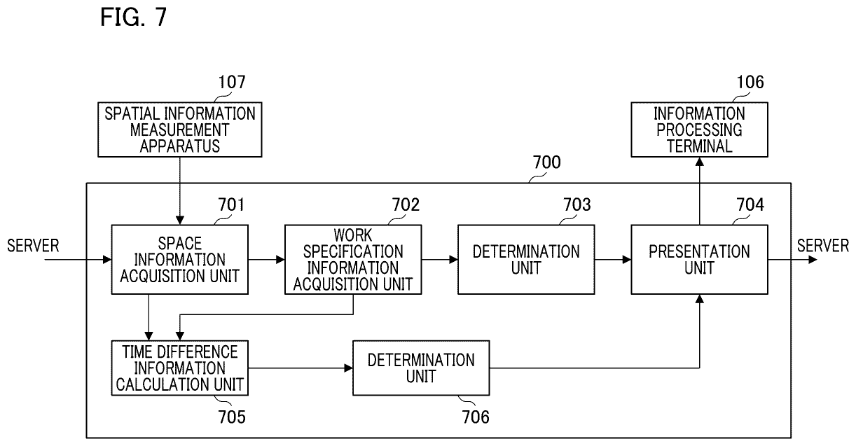

In addition, each of the functional blocks shown in FIG. 2 need not be incorporated into the same housing, and may be configured by separate apparatuses connected to each other via signal paths. It should be noted that the above-described explanation related to FIG. 1 similarly applies with respect to FIG. 7.

The information processing apparatus 200 creates an execution plan for work specification information based on information of the physical space and work specification information and the like, and together with creating the execution plan, specifies information that is lacking and presents the lacking information to a requester. Reference numeral 201 denotes a space information acquisition unit configured to acquire space information that is information of a physical space sensed by the requester using a spatial information measurement apparatus 107 such as a camera and LiDAR, and furthermore, to acquire maps and floor plan information from, for example, a server and the like.

Reference numeral 202 denotes a work specification information acquisition unit configured to acquire work specification information, wherein the work specification information is specification information of work performed by a robot serving as a movable apparatus that autonomously operates based on the information of the physical space received by the space information acquisition unit 201.

Reference numeral 203 denotes a determination unit configured to determine, based on physical space information acquired by the space information acquisition unit 201 and work specification information acquired by the work specification information acquisition unit 202, lacking information that is lacking when planning execution of work that is defined in advance by the work specification information.

Reference numeral 204 denotes a presentation unit configured to present and request the lacking information determined by the determination unit 203 by transmitting the lacking information to the information processing terminal 106 operated by the requester 101 of the work, and, at the same time, transmit data to a server and the like configured to store information.

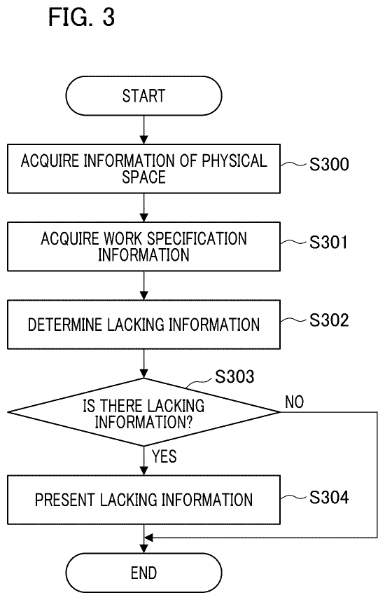

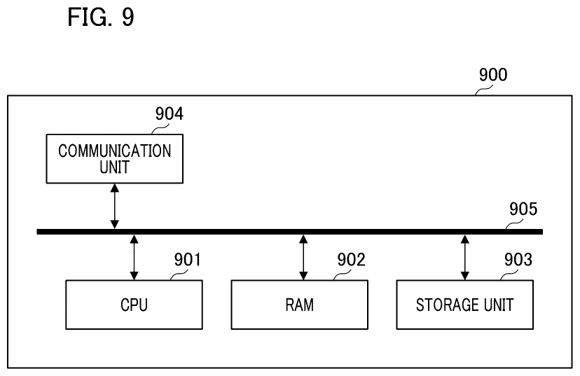

Next, the flow of processing of the First Embodiment will be explained by using FIG. 3. FIG. 3 is a flowchart showing an example of a basic processing flow according to the First Embodiment. It should be noted that the operation of each step in the flowchart of FIG. 3 is sequentially performed by a CPU 901 (refer to FIG. 9) serving as a computer in the information processing apparatus 200 executing a computer program stored in memory.

In step S300, the CPU 901 acquires information of a physical space by means of the space information acquisition unit 201. Here, step S300 functions as a space information acquisition step of acquiring space information, wherein the space information is information of a physical space.

It should be noted that, in the present embodiment, the information of the physical space acquired in step S300 is data wherein the requester has sensed the entire space that becomes the work target, and is that to which concealment processing has been applied to regions that include confidential information. However, the present embodiment includes cases in which the information of the physical space does not include concealed regions.

In step S301, the CPU 901 acquires work specification information by using the work specification information acquisition unit 202. The work specification information in the present embodiment is information that includes information indicating a region for executing work from among the physical space information, and type information indicating a type of work. In the present embodiment, the type of work is floor cleaning.

Step S301 functions as a work specification information acquisition step of acquiring work specification information, wherein the work specification information is specification information of work performed by an autonomously movable apparatus in a space. In step S302, the CPU 901, by means of the determination unit 203, specifies information lacking for planning execution of work within the work target region acquired by the work specification information.

For example, for floor cleaning, the time required for executing work and the performance required of the robot are determined by shapes such as floor unevenness, materials, and the like. Therefore, information such as floor shapes, materials, colors, and the like becomes necessary information. Therefore, in step S302, a search is performed for an overlapping region between a region in which work is executed in the information of the physical space and regions in which concealment processing has been applied.

Then, in a case in which an overlapping region exists, with respect to the overlapping region, information types (types of information) that are concealed are searched for from the information of the physical space, and the overlapping region is determined as a region in which information is lacking.

Furthermore, whether information types necessary for executing work (information such as floor shapes (such as unevenness and the like), floor materials, floor colors, and the like) are included is determined, and information types not included are determined as types of information that is lacking. That is, information types that are concealed are determined as information types that are lacking. In contrast, in a case in which no overlapping region exists, regions in which information is lacking and information types that are lacking are determined to be “none”.

In step S303, the CPU 901 determines, by means of the determination unit 203, whether or not there is information that becomes lacking when planning execution of work that is defined by the work specification information. That is, in step S303, the result of step S302 is referenced, and in a case in which there is no region in which information is lacking and there are no information types that are lacking, the flow of FIG. 3 ends.

In a case in which YES is determined in step S303, the processing proceeds to step S304. Here, steps S302 to S303 function as a determination step of determining lacking information related to space information that is lacking in planning execution of work that is defined by the work specification information based on the space information and the work specification information.

Then in step S304, the CPU 901, by means of the presentation unit 204, presents and requests to the information processing terminal 106 of the requester the region in which information is lacking and information types that are lacking specified in step S302. Step S304 functions as a presentation step of presenting information that is lacking determined in the determination step to the requester of the work.

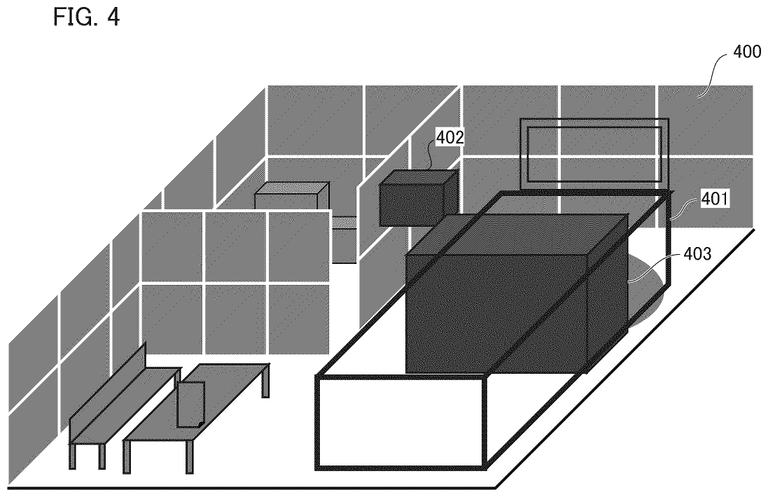

FIG. 4 is a diagram showing an example of information of a physical space according to the First Embodiment, and shows a specific example of information of the physical space acquired in step S300. Reference numeral 400 denotes the entire information of the physical space, and includes information in which concealment processing has been applied to confidential information. The information processing apparatus 200 acquires, in step S300, the entire information 400 of the physical space as shown in FIG. 4.

Reference numeral 401 denotes a work target region within the information of the physical space, and reference numerals 402 and 403 show concealed regions in which concealment processing has been applied to regions that include confidential information in the entire information 400 of the physical space. In this manner, in the present embodiment, the physical space shall include concealed regions and the like in which concealment processing has been applied to regions that include information related to confidentiality.

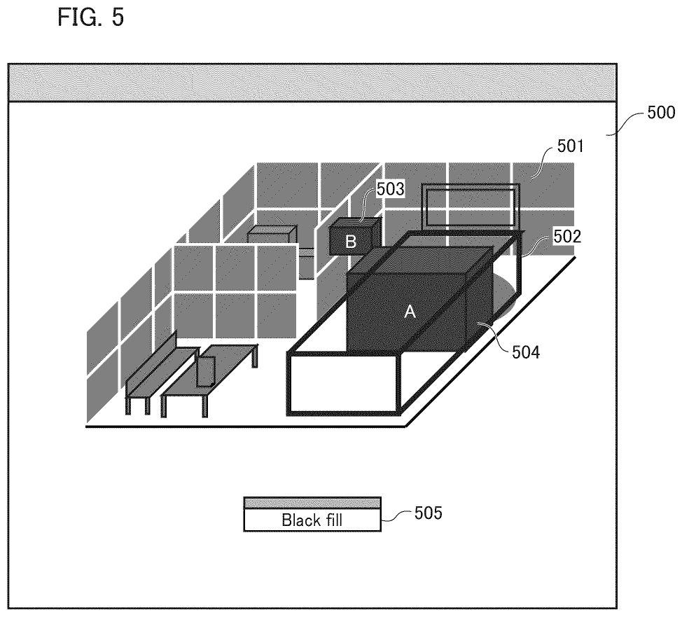

Next, FIG. 5 is a diagram showing an example of a user interface when performing concealment processing on information of a physical space according to the First Embodiment. In FIG. 5, reference numeral 500 shows a UI for performing concealment processing on regions that include confidential information in the entire information of the physical space sensed by using a sensor.

Reference numeral 501 denotes the entire information of the physical space, and reference numeral 502 represents a work target region within the entire information of the physical space. Reference numerals 503 and 504 denote concealed regions in which concealment processing has been performed by a concealment method (for example, “black fill”) selected in menu 505 on information related to privacy and confidentiality. It should be noted that although there may be cases in which the requester 101 sets the concealed regions, a third party (for example, a facility administrator and the like) other than the requester 101 may also set the concealed regions.

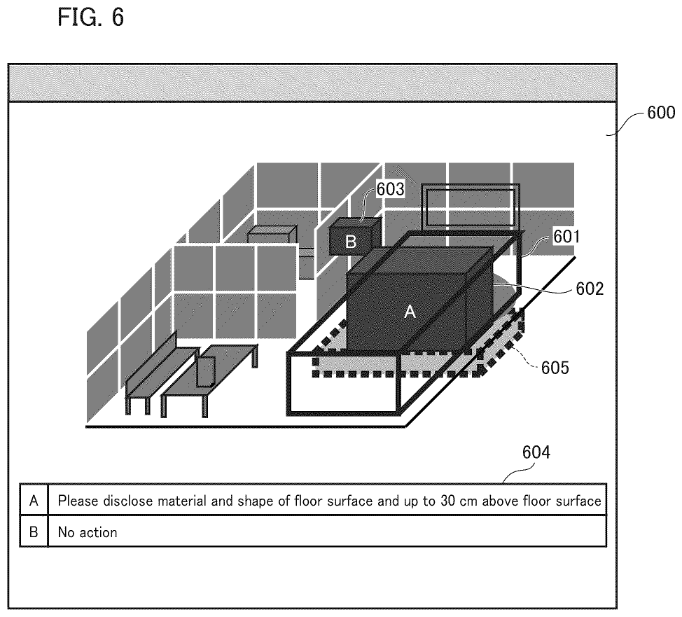

Here, using FIG. 6, an example of presentation content and presentation method by the presentation unit 204 in the present embodiment will be explained. FIG. 6 is a diagram showing an example of a user interface when presenting information that is lacking to a requester in the First Embodiment.

Reference numeral 600 denotes a UI (user interface) screen that is configured to present locations determined to be lacking with respect to the entire information of the physical space provided by the requester. Reference numeral 601 denotes a work target region within the entire information of the physical space. Reference numeral 604 denotes presentation and requesting, with respect to concealed regions 602 and 603, of information that has been determined to be lacking and that requires disclosure, for each concealed region.

Reference numeral 604 denotes an example of searching for an overlapping region between the work target region 601 and the concealed region 602, and presenting and requesting the location and type of information that is lacking. That is, in row A of 604, the following is presented as an example: “Please disclose the material and shape of the floor surface and up to 30 cm above the floor surface.”

That is, information that is lacking and that becomes necessary for planning execution of work is indicated and requested, such as the arrangement of objects existing on the floor surface and up to 30 cm above the floor surface in region 605, and the material and shape of the floor surface and the like. In addition, in 604, row B shows that there is no information that is lacking in region 603.

As explained above, according to the First Embodiment, the information processing apparatus and information processing method enable generation of work plans for robots and the like while considering privacy, confidentiality and the like in the information of the physical space.

It should be noted that in the present embodiment, an example of generating information of a physical space based on measurement values of sensors has been explained. However, provided that the conditions necessary for executing work planning can be understood, such as shapes of work target locations and arrangement of objects existing in work target locations, generating information of the physical space is not limited to using measurement values of sensors.

For example, information of a physical space may be generated from design data such as CAD (Computer Aided Design) data and BIM (Building Information Modeling) data. If design data is utilized, the time and effort for generating space information from sensing and sensor measurement values can be eliminated. Alternatively, information of a physical space may be generated from both sensor measurement values and design data.

In addition, information indicating content of work given by work specification information acquired in step S301 of FIG. 3 need only be at a granularity level wherein work content is understandable for planning execution of work. For example, at a granularity level of wiping cleaning, compared to a granularity level of cleaning, lacking information need only be specified for a region limited to a floor surface or several centimeters above the floor surface, and it is possible to limit locations requiring disclosure.

In this manner, information indicating content of work such as cleaning may include information related to details of work content and methods. For example, the work content may be a type such as “cleaning” or a detailed type such as “wiping cleaning”. In addition, for example, in a case in which the work is “wiping cleaning”, the information may include information related to details of the work method such as “dry wiping” or “wet wiping”.

However, in a case of work content such as transportation of objects, although the requester need only specify a start point and an end point, when planning execution of work such as transportation, processing for calculating a transport route between the start point and the end point is added.

It should be noted that although step S303 of FIG. 3 was explained taking as an example concealing information related to privacy and confidentiality, for information of a physical space that is not concealed, information that is lacking for performing work may be specified if such information exists.

It should be noted that reference numeral 505 in FIG. 5 was explained as an example of using black-filled cubic shapes for concealing regions related to privacy and confidentiality. However, provided that a processing method performs concealment, the processing method is not limited thereto, and information may be concealed by mosaic processing, mask processing, deletion of data, color and brightness information only, low resolution processing, and the like. In addition, the information processing apparatus according to the present embodiment may be provided with a movable apparatus performance acquisition unit for acquiring performance of a robot.

That is, performance related to a robot serving as a movable apparatus is acquired by means of the movable apparatus performance acquisition unit. Specifically, information related to performance of the movable apparatus is acquired, such as positioning accuracy of the movable apparatus, accuracy of self-position measurement, size of the movable apparatus, allowable step differences that can be traversed, weight of the movable apparatus, turning radius, climbing ability, detection accuracy of obstacles, and the like.

When planning execution of work, by using the acquired information related to performance of the movable apparatus, a work robot suitable for the work environment is selected. Specifically, with respect to allowable step differences and climbing ability, performance of the movable apparatus is referenced and a work robot that satisfies constraint conditions of the work target region is selected.

With respect to other performance, based on object arrangement information in the work target region and performance of the movable apparatus, a work robot with specifications that prevent collision with surrounding objects when executing work with respect to the work target region is selected.

In addition, there may be cases in which information necessary for specifying information lacking for planning execution of work depends on performance of the movable apparatus. Specifically, for a movable apparatus having low climbing ability, compared to a movable apparatus having high climbing ability, information with respect to inclination angles becomes more necessary when specifying information that becomes lacking for planning execution of work.

In addition, as the performance of the movable apparatus becomes lower, more accurate and detailed information of the physical space becomes necessary. Therefore, information that becomes lacking for planning execution of work may be specified based on acquired performance of the movable apparatus.

### Second Embodiment

In the First Embodiment, an example was explained of specifying information that is lacking for planning work based on work specification information of work performed by an autonomously operating mechanical apparatus from among information of a physical space, and presenting and requesting the lacking information. In the Second Embodiment, a method is explained of determining a reward according to an amount of collected information.

FIG. 7 is a functional block diagram showing a configuration example of an information processing apparatus 700 according to a Second Embodiment. Although the following explains main parts of the information processing apparatus 700, the information processing apparatus 700 may be provided with other processing units. Reference numeral 701 denotes a space information acquisition unit, 702 denotes a work specification information acquisition unit, 703 denotes a determination unit, and 704 denotes a presentation unit, and because 701 to 704 are functional blocks similar to 201 to 204 in FIG. 2, an explanation thereof will be partially omitted.

The work specification information acquisition unit 702 acquires specification information of work performed by a robot serving as an autonomously moving movable apparatus within the information of the physical space received by the space information acquisition unit 701. The content of the specification information acquired in the Second Embodiment, in addition to the content explained in the First Embodiment, includes work start time information.

Reference numeral 705 denotes a time difference information calculation unit configured to acquire, using the space information acquisition unit 701, the time at which the information of the physical space was acquired from the spatial information measurement apparatus 107, and calculates the difference between the time at which the information of the physical space was acquired and the work execution start time acquired by the work specification information acquisition unit 702.

Reference numeral 706 denotes a determination unit configured to determine a reward grant rate to be given to the requester 101 based on the time difference calculated by the time difference information calculation unit 705. It should be noted that the reward grant rate determined by the determination unit 706 is presented and requested to the information processing terminal 106 by the presentation unit 704, and data is transmitted to a server and the like for storing information.

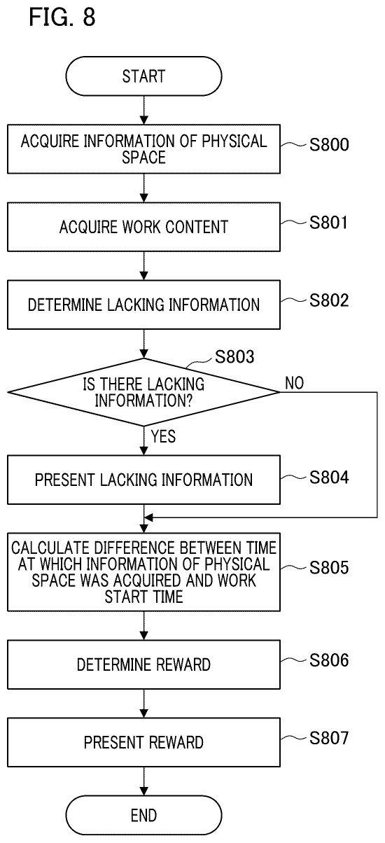

Next, FIG. 8 is a flowchart showing a basic processing flow according to the Second Embodiment. It should be noted that the operation of each step in the flowchart of FIG. 8 is sequentially performed by the CPU 901 (refer to FIG. 9) serving as a computer in the information processing apparatus 200 executing a computer program stored in memory.

Because step S800 is processing similar to that of step S300 in FIG. 3, an explanation thereof will be omitted. In step S801, the CPU 901 acquires work specification information by means of the work specification information acquisition unit 702.

The work specification information acquired in step S801 includes information related to work start time and the like, in addition to information related to work content, such as cleaning, delivery, and security. It should be noted that although the Second Embodiment explains an example of using work start time, information related to work end time and budget and the like may be included. Because steps S802 to S804 are processing similar to that of steps S302 to S304 in FIG. 3, an explanation thereof will be omitted.

In step S805, the CPU 901, by means of the time difference information calculation unit 705, calculates a difference between the time at which physical space information acquired in step S800 was acquired and the work start time acquired in step S801. In step S806, the CPU 901, by means of the determination unit 706, determines a reward based on the time difference information calculated in step S805.

It should be noted that although there is no particular limitation with respect to the reward grant rate, in the Second Embodiment, for example, the reward grant rate is determined according to the magnitude of a calculated difference. Specifically, in a case in which the calculated difference is small, a larger reward is granted compared to a case in which the difference is large. In addition, the reward to be granted takes the form of coupons, discount tickets, or reflection into usage fees and the like. It should be noted that the reward in the present embodiment may include not only the reward itself but also the reward grant rate.

In step S807, the CPU 901, by means of the presentation unit 704, presents the reward (or reward grant rate) determined in step S806 to the information processing terminal 106.

According to the above sequence, the information processing apparatus and information processing method according to the Second Embodiment enable collection of information while considering privacy in the information of the physical space. Furthermore, because the reward (or reward grant rate) is determined according to the amount of collected information at this time, when planning work based on work specification information of work performed by autonomously operating robots and the like from among information of the physical space, it becomes possible to improve accuracy.

It should be noted that instead of the time difference information calculation unit 705, a space information difference calculation unit may be provided, and the reward grant rate may be determined based on a difference calculated by the space information difference calculation unit. The space information difference calculation unit calculates a space information difference, wherein the space information difference is a difference between information of a physical space at a time of measurement by the requester and information of a physical space at a time of real-time measurement by a robot serving as a movable apparatus. In a case in which the space information difference is small, the reward grant rate is granted at a larger amount compared to a case in which the difference is large.

It should be noted that in a case in which both the information of the physical space that the requester has measured and the information of the physical space that the robot has measured in real-time are three-dimensional shape models, the difference in physical space information is calculated by calculating a total sum or average value of distances between corresponding points on both models.

In contrast, in a case in which both the space information measured by the requester and the space information measured in real-time by the robot is point clouds, after aligning multiple point cloud data by using known technology, a total sum or average value of distances between corresponding point clouds is calculated. It should be noted that the method of calculating the difference need not be limited provided that the method calculates a difference between information at a time of measurement by the requester and information at a time of measurement by the robot.

The determination unit 706 may determine a reward (or reward grant rate) to be granted to the requester based on at least one of the time difference at the time calculated by the time difference information calculation unit 705 and the space information difference of the physical space information calculated by the space information difference calculation unit.

It should be noted that the reward (or reward grant rate) may be determined based on a difference between work execution time calculated when planning execution of work and actual work time required when the robot serving as a movable apparatus executed the work. Alternatively, the reward (or reward grant rate) may be determined based on a difference between an amount of work calculated when planning execution of work and an actual amount of work performed by the robot.

It should be noted that in a case in which at least one of the time difference and the space information difference is small, the reward (or reward grant rate) is granted at a larger amount compared to a case in which the difference is large. That is, the smaller the difference, the larger the reward (or reward grant rate) becomes.

In addition, the reward may be determined according to an amount or ratio of lacking information determined by the determination unit 703. Specifically, the reward is determined according to a ratio of disclosed information from among information that becomes necessary for planning execution of work that is defined by the work specification information. In a case in which the ratio of disclosed information is high, the reward grant rate is made higher compared to a case in which the ratio is low.

However, in a case in which a concealed region exists within the work target region, because the amount of lacking information is unclear, the reward may be determined according to a ratio of concealed regions within the work target region. In a case in which the ratio of concealed regions from among the work target region is high, the reward grant rate is made lower compared to a case in which the ratio is low.

It should be noted that the reward grant rate may be calculated by using a difference obtained by one calculation method from among these plurality of calculation methods, or the reward grant rate may be calculated by combining differences obtained by each of these plurality of calculation methods by applying weighting coefficients thereto. By calculating the reward grant rate as described above, accuracy of work planning can be further improved by encouraging the requester to provide information necessary when the robot performs work.

### Third Embodiment

In the First Embodiment, an example of collecting information while considering privacy in a case of entire information of a physical space was explained, and in the Second Embodiment, an example of determining a reward according to an amount of collected information was explained. In the Third Embodiment, an example of performing feedback with respect to an amount of entire information of the physical space provided by a requester is explained.

It should be noted that the configuration of the Third Embodiment may be substantially identical to the configuration of the information processing apparatus according to the Second Embodiment shown in FIG. 7. That is, 701 to 703, 705, and 706 may be functional blocks similar to those of the Second Embodiment, and an explanation thereof will be omitted. The presentation unit 704 in the Third Embodiment presents feedback information regarding information of the physical space provided by the requester to the information processing terminal 106.

Specifically, in a case in which there is an image difference equal to or greater than a predetermined threshold before and after work execution by the robot, the information processing apparatus provides feedback to the requester by presenting lacking information of concealed regions within the information of the physical space to the information processing terminal 106.

For example, in a case in which there is a difference in physical space information calculated by the space information difference calculation unit and the difference is equal to or greater than a predetermined threshold, feedback is provided to the requester by presenting lacking information for concealed regions and the like within the information of the physical space to the information processing terminal 106.

In addition, accuracy prediction information in a case in which information of concealed regions within the information of the physical space is disclosed, and information of additional rewards to be granted in a case in which the requester discloses information of concealed regions may also be presented to the information processing terminal 106. Feedback may be provided to the requester in such a manner, and the content of the feedback is not particularly limited.

It should be noted that, with respect to the specific calculation method of accuracy prediction information, the method determines, for example, in a case in which there was work content that could not actually be performed from among work content estimated when planning execution of work, whether or not the work region of work that could not be performed overlaps with concealed regions.

In a case in which the work region of work that could not be performed overlapped even partially with concealed regions, the accuracy prediction information calculation method determines that the estimated work content can be performed in a case in which the requester discloses information of concealed regions and the like. Furthermore, accuracy is predicted based on a ratio that work content in concealed regions accounts for with respect to all work content. In addition, the reward grant rate may be calculated by using the method that was explained in the Second Embodiment.

According to the information processing apparatus of the Third Embodiment, it becomes possible to perform feedback to the requester with respect to an amount of information of the physical space provided by the requester. Thereby, because the requester understands an amount of information that should be provided at subsequent request times, an appropriate amount of information can be provided next time. That is, when planning execution of work, it is possible to improve accuracy at the time of planning execution of work compared to the initial planning time.

It should be noted that FIG. 9 is a diagram showing a hardware configuration example of the information processing apparatus according to the First to Third Embodiments. Reference numeral 900 denotes an information processing apparatus. Reference numeral 901 denotes a CPU, 902 denotes a RAM, 903 denotes a storage unit serving as a storage medium such as an HDD or SSD, 904 denotes a communication unit, and 905 denotes a system bus.

The CPU 901 uses the RAM 902 serving as a work memory, executes an OS (Operating System) and various computer programs stored in the storage unit 903, and controls each part of the information processing apparatus via the system bus 905. Thereby, the information processing method shown in the flowcharts of FIG. 3 and FIG. 8 can be executed.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-020684, filed on Feb. 14, 2024, which is hereby incorporated by reference herein in its entirety.

What is claimed is:

1. An information processing apparatus comprising:
one or more memories storing instructions; and
one or more processors executing the instructions to:
acquire space information, wherein the space information is information of a physical space;
acquire work specification information, wherein the work specification information is specification information of work performed by an autonomously moving movable apparatus in the physical space;
determine, based on the space information and the work specification information, lacking information that is lacking with respect to the space information for planning execution of the work that is defined by the work specification information; and
present the lacking information that was determined to a requester of the work.

2. The information processing apparatus according to claim 1, wherein the work specification information includes information that indicates a type of the work and information that indicates a region in which the work is executed from among the space information acquired.

3. The information processing apparatus according to claim 1, wherein the space includes a concealed region in which concealment processing has been applied to a region that includes information related to confidentiality.

4. The information processing apparatus according to claim 3, wherein the determination of lacking information comprises, searching for an overlapping region between the region in which the work is executed and the concealed region, and in a case in which the overlapping region exists, determining whether information types necessary for executing the work are included in the overlapping region, and determining information types not included therein as types of the deficient information.

5. The information processing apparatus according to claim 1, wherein the one or more processors further execute the instructions to:
perform at least one of
processing that calculates a time difference between a time at which the space information was acquired and an execution start time of the work, and
processing that calculates a space information difference between the space information and the space information at a time when the movable apparatus measured the space information; and
determine a reward to be granted to the requester based on at least one of the time difference and the space information difference.

6. The information processing apparatus according to claim 5, wherein the reward is made larger as at least one of the time difference and the space information difference becomes smaller.

7. The information processing apparatus according to claim 1, wherein the one or more processors further execute the instructions to determine a reward to be granted to the requester.

8. The information processing apparatus according to claim 7, wherein the reward is determined based on a difference between work execution time calculated when planning execution of the work and actual work time taken when the movable apparatus executed the work.

9. The information processing apparatus according to claim 7, wherein the reward is determined based on a difference between an amount of work calculated when execution of the work was planned and an actual amount of work performed by the movable apparatus.

10. The information processing apparatus according to claim 7, wherein the reward is determined according to an amount or ratio of the lacking information.

11. The information processing apparatus according to claim 7, wherein the reward is determined according to a ratio of a concealed region from among a work target region.

12. The information processing apparatus according to claim 8, wherein the reward is made larger as the difference becomes smaller.

13. An information processing method comprising:
acquiring space information, wherein the space information is information of a physical space;
acquiring work specification information, wherein the work specification information is specification information of work performed by an autonomously moving movable apparatus in the physical space;
determining, based on the space information and the work specification information, lacking information that is lacking with respect to the space information for planning execution of the work that is defined by the work specification information; and
presenting the lacking information that was determined to a requester of the work.

14. A non-transitory computer-readable storage medium storing a computer program including instructions for executing following processes:
acquiring space information, wherein the space information is information of a physical space;
acquiring work specification information, wherein the work specification information is specification information of work performed by an autonomously moving movable apparatus in the physical space;
determining, based on the space information and the work specification information, lacking information that is lacking with respect to the space information for planning execution of the work that is defined by the work specification information; and
presenting the lacking information that was determined to a requester of the work.
